(19) United States
(12) Patent Application Publication
(10) Pub. No.: US 2012/0094042 A1
(43) Pub. Date: Apr. 19, 2012

(54) HEAT SEALABLE MONOAXIALLY ORIENTED PROPYLENE-BASED FILM WITH DIRECTIONAL TEAR

(75) Inventors: Mark S. LEE, North Kingstown, RI (US); Harold Egon KOEHN, North Kingstown, RI (US); Nao YOKOTA, North Kingstown, RI (US); Emilio COLETTA, North Kingstown, RI (US); Matthew H. BROWN, Wakefield, RI (US)

(73) Assignee: TORAY PLASTICS (AMERICA), INC., N. Kingstown, RI (US)

(21) Appl. No.: 13/290,444

(22) Filed: Nov. 7, 2011

Related U.S. Application Data
(63) Continuation-in-part of application No. 12/542,385, filed on Aug. 17, 2009.
(60) Provisional application No. 61/089,121, filed on Aug. 15, 2008.

(51) Int. Cl. B32B 27/08; C08L 23/14; C08L 23/20; C08L 23/12

(52) U.S. Cl. 428/35.7; 428/515; 525/322; 524/528

(57) ABSTRACT

A monoaxially oriented films and methods of making films including a heat sealable layer including propylene homo-polymer or copolymer and 3-15 wt % of at least one elastomer. The oriented films have a refractive index that satisfies the condition 5≦delta n=|n (MD)−n (TD)|×1000≦25, in which n (MD) is a refractive index of the film in a machine direction, and n (TD) is a refractive index of the film in a transverse direction. The films are suitable for pouch applications requiring an “easy-tear” linear tear feature and excellent hermetic seal properties, particularly for retort pouches

### CROSS-REFERENCE TO RELATED APPLICATIONS

This application is a continuation-in-part of U.S. patent application Ser. No. 12/542,385, filed Aug. 17, 2009, which claims the benefit of U.S. Provisional Patent Application Ser. No. 61/089,121, filed Aug. 15, 2008, the contents of which are incorporated herein by reference.

### FIELD OF THE INVENTION

This invention relates to a monoaxially oriented heat sealable propylene-based film which exhibits excellent sealability and directional tearability.

### BACKGROUND OF THE INVENTION

Cans and retortable pouches have been used routinely for the preservation and packaging of pre-cooked foods without additional preservation techniques such as freezing, pickling, salting, drying, or smoking. Such canning and retorting applications subject the food contents to high temperatures for short time periods which effectively cook the contents within the container and/or sterilize the contents such that the contents remain safely preserved until used by the consumer.

With the increasing cost of metals and metal processing, flexible retort pouches are becoming more popular as a cost-effective method to package such pre-cooked foods. Flexible retort pouches are lighter in weight and this saves in transportation costs. In addition, they have excellent printing characteristics and can provide more visual “pop” than paper labels for metal cans.

The typical retort pouch is a laminate of several films. The laminate may include a film layer that can be printed for the marketing of the food product; a barrier film layer to inhibit the diffusion of oxygen and moisture and thus prolong the shelf-life of the product; and a sealant film layer which provides hermetic seals which also helps prevent ingress of gases or microbes that may shorten the shelf-life of the product or cause spoilage. In addition, this sealant film layer may provide high seal strengths that can withstand the retorting process. Typically, this sealant film layer is a non-oriented, cast polypropylene or polyethylene-based film. During retorting, high temperatures are used to sterilize and/or cook the contents and pressure can build up within the pouch as a result of this heating. Thus, the sealant component of the pouch must be formulated to be able to withstand both the high temperatures and pressures that result from the retort process and thus, maintain the integrity of the pouch. Moreover, the formulation of the sealant component (as well as the other components of the pouch) must be compliant to food packaging regulations for retort applications such as stipulated by US Food and Drug Administration (FDA) 21 CFR 177. 1390 which specifies the materials that can be used to construct flexible retort packages and compliance guidelines for migratory testing.

However, the high seal strengths required for retort packaging also make it difficult for the consumer to open the pouch by hand, especially if the retort package is made of all polymeric films. Scissors or sharp implements typically must be used to open such pouches. To make the pouches more user-friendly, notches can be used to enable the consumer to easily initiate a tear and thus open the pouch. However, such a tear can easily result in “zippering” of the pouch whereby the tear is not uniformly parallel to the top edge of the pouch but can become vertical or diagonal to the top of the pouch and cause a potential loss or spillage of the contents during opening. To rectify this, some solutions involve perforating a tear-line with the notch in order to keep the tear directionally parallel to the top of the pouch and thus prevent zippering. These perforations are often accomplished using mechanical perforators or lasers. Some concerns using perforation techniques are not only additional cost, but also the potential compromising of barrier properties since these techniques are essentially perforating the pouch laminate.

Another method to impart directional tear properties may include orienting the cast polypropylene film typically used in retort applications. However, the process of orienting such a film--either monoaxially or biaxially--typically diminishes the seal properties in that the seal initiation temperature (SIT) of the film is raised and the overall seal strengths are weaker. Without being bound by any theory, this is believed to be due to the fact that the orientation process aligns the amorphous regions into a more ordered configuration, raising the Tg of the film, and thus, seal properties are poorer. This is why unoriented cast polypropylene works well as a sealant film versus, for example, biaxially oriented polypropylene film (BOPP) which generally functions poorly as a sealant film. (This is assuming that no coextruded random copolymer heat sealable resins are used as part of the BOPP film.) There is typically a minimum and maximum range for monoaxial orientation stretching. If the orientation is not enough, the film usually suffers from uneven stretching mark defects, and if the orientation is too much, processing stability can be difficult to maintain, as the film may be prone to breakage at this high orientation rate.

U.S. Pat. No. 6,541,086 B1 describes a retort package design using an oriented polymer outer film (suitable for printing), an aluminum foil as a barrier film, a second oriented intermediate polymeric film, and a non-oriented polyolefin for the sealant film. Easy-tear functionality is added by surface roughening the two oriented polymer films and overlapping them in a particular formation. The particular specific order of laminating the films and the surface roughening by sandpaper provides for easy-tear properties and presumably directional tear, but this process involves additional films and extra steps to accomplish the desired tear properties.

U.S. Pat. No. 6,719,678 B1 describes a retort package design using multiple film layers whereby the intermediate layers (“burst resistant layer”) are scored by a laser such that the score lines provide an easy-tear feature and a directional tear feature.

U.S. Pat. No. 6,846,532 B1 describes a retort package design intended to reduce cost by enabling the reduction of layers from typically 4 plies to 3 plies. The heat sealable layer is a non-oriented cast polypropylene film and no directional tear properties are included.

U.S. Pat. No. 5,756,171 describes a retort package design using multiple layers of films including polyolefin film layers intended to protect the inner barrier layer from hydrolysis effects. These polyolefin film layers include a rubber-type elastomer mixed into an ethylene-propylene copolymer. However, there are no directional properties included.

U.S. Pat. No. 4,903,841 describes a retort package design that utilizes a non-oriented cast polypropylene film as the sealable layer. The films are surface-roughened or scored in a particular manner so as to impart directional tear properties.

U.S. Pat. No. 4,291,085 describes a retort package design using a non-drawn, non-oriented cast crystalline polypropylene film as the sealable layer with specific crystalline structure and orientation of the crystalline structures which must be less than 3.0. There are no directional tear properties included.

U.S. Pat. No. 5,786,050 describes an “easy opening” pouch design which has as the inner ply (which contacts the pouch's contents) a sealant film including a linear low density polyethylene; an intermediate layer composed of an oriented polyolefin with an MD/TD ratio of greater than 2; and an outermost layer of biaxially oriented PET or nylon film. The inner ply sealant of linear low density polyethylene is non-oriented. The specific orientation ratios of the intermediate film impart easy-tear properties.

U.S. Pat. No. 4,834,245 describes a pouch design having a “tearing zone” using a monoaxially oriented film with a pair of notches aligned with the tearing direction and the direction of orientation of said film. The monoaxially oriented film which imparts the “tearing zone” is on the outside of the pouch and does not contact the pouch contents and is not designed or considered to be appropriate for heat-sealability.

U.S. patent application Ser. No. 11/596,776 describes a pouch design including at least one uni-directionally stretched film. The preferred embodiments describe a uni-directionally stretched polypropylene film or uni-directionally stretched polyethylene terephthalate film which imparts the easy tear property. The application is silent as the sealing properties of these layers or even which layer should be the sealant film.

### SUMMARY OF THE INVENTION

Described are monoaxially oriented films and methods of making films including a heat sealable layer including propylene homo-polymer or copolymer and 3-15 wt % of at least one elastomer. The oriented films have a refractive index that satisfies the condition 5≦delta n≦25, in which n (MD) is a refractive index of the film in a machine direction, and n (TD) is a refractive index of the film in a transverse direction. The films are suitable for pouch applications requiring an “easy-tear” linear tear feature and excellent hermetic seal properties, particularly for retort pouches. Better seal properties are achieved by controlling orientation of the film, not only by stretching ratio but also including other parameters such as refractive index without jeopardizing the other critical qualities such as directional tear properties.

One embodiment is a monoaxially oriented heat-sealable single layer film including a propylene homo-polymer or copolymer and 3-15 wt % of at least one elastomer. The refractive index of the film satisfies the following condition:

5≦delta n≦25, wherein

delta n=|n(MD)−n(TD)|×1000

n (MD) is a refractive index of the film in a machine direction, and

n (TD) is a refractive index of the film in a transverse direction.

The film may include 75-97 wt % propylene homo-polymer or copolymer. The film may include propylene-butene elastomer or ethylene-butene elastomer. For example, the film may include a propylene-butene elastomer having a butene content of 15-30 wt %, a metallocene-catalyzed propylene-butene elastomer, or a metallocene catalyzed ethylene-butene elastomer. The film may also include an inorganic antiblock agent. The film may be used, for example, for a food package.

Another embodiment is a multi layer film including a heat sealable layer including a propylene homo-polymer or copolymer and at 3-15 wt. % of at least one elastomer, and a core layer. The refractive index of the film satisfies the following condition:

5≦delta n≦25, wherein

delta n=|n(MD)−n(TD)|×1000

n (MD) is a refractive index of the film in a machine direction, and

n (TD) is a refractive index of the film in a transverse direction.

The heat sealable layer may include a propylene-butene elastomer or ethylene-butene elastomer. The heat sealable layer preferably has a thickness of 5-50% of the total thickness of the film.

The core layer may include an ethylene-propylene copolymer. For example, the core layer may include an isotactic ethylene-propylene copolymer with an with an ethylene-propylene rubber content of 10-30 wt % and an ethylene content of the ethylene-propylene rubber is 10-80 wt %. The core layer may include an ethylene-propylene copolymer, or propylene copolymer.

The heat sealable layer may include 75-97 wt % propylene homo-polymer or copolymer. The elastomer may be a propylene-butene elastomer having a butene content of 15-30 wt %. For example, the elastomer may be a metallocene-catalyzed propylene-butene elastomer, or a metallocene catalyzed ethylene-butene elastomer. The film may include an inorganic antiblock agent. The film may be used, for example, for a food package.

An embodiment of a method of making a monoxially oriented film may include extruding a single layer film including a propylene homo-polymer or copolymer and 3-15 wt % of at least one elastomer, and monoaxially orienting the single layer film. The refractive index of the film satisfies the following condition:

5≦delta n≦25, wherein

delta n=|n(MD)−n(TD)|×1000

n (MD) is a refractive index of the film in a machine direction, and

n (TD) is a refractive index of the film in a transverse direction.

An embodiment of a method of making a multilayer monoxially oriented film includes co-extruding a heat sealable layer including a propylene homo-polymer or copolymer and at 3-15 wt. % of at least one elastomer, and a core layer. The refractive index of the film satisfies the following condition:

5≦delta n≦25, wherein

delta n=|n(MD)−n(TD)|×1000

n (MD) is a refractive index of the film in a machine direction, and

n (TD) is a refractive index of the film in a transverse direction.

### BRIEF DESCRIPTION OF THE DRAWINGS

FIG. 1 is graph of the relationship between Trouser tear resistances versus delta n.

FIG. 2 is diagram of a pouch with a branched section that was hand made as using a laminate.

### DETAILED DESCRIPTION OF THE INVENTION

This invention relates to a monoaxially oriented heat sealable propylene-based film which exhibits excellent sealability and directional tearability. This film may be well-suited as the sealable film component for food package applications including retort pouch packaging applications. In addition, it may be suitable for packages that are hand-tearable. The films may allow for the tear line to be controlled and consistent across the top of the pouch and parallel to the top of the pouch, without causing “zippering” of the pouch and subsequent potential loss of the contents. The described films combine both excellent seal strengths and hermetic seals suitable for retorting and directional tear, obviating the need for perforation techniques to enable directional tear.

In some embodiments, the inventors have found that the above attributes of directional tear and heat sealability may be balanced by a formulation and orientation properties of the film. The formulation may include an amount of at least one propylene-butene elastomer and an optional amount of at least one ethylene-butene copolymer blended with the major component which is a propylene-based homo- or copolymer resin. The directional tear property may be imparted via one direction orientation of the cast film. This combination of orientation and resin formulation provides excellent directional tear properties without compromising the high seal strength and hermetic seal properties that may be desired for retort pouches.

Accordingly, one embodiment is a monoaxially oriented film including a single heat sealable layer (A) containing propylene homo-polymer or copolymer as a major component, preferably blended with an amount of propylene-butene elastomer. An optional amount of ethylene-butene elastomer may also be blended. Another embodiment may include a multi-layer film in which a core polyolefin resin-containing layer and at least one heat sealable layer (A) may be coextruded. This core polyolefin resin-containing layer may be considered a base layer to provide the bulk strength of the multi- layer film. Preferably, this core layer (B) may also include an ethylene-propylene copolymer or include a propylene homopolymer or propylene copolymer. The layer (A) can be the same thickness as the (B) core layer, but preferably is thinner than the (B) core layer. For example, the layer (A) may be about 5-50% of the total thickness of the (A) and (B) layers combined, more preferably 10-30% of the total thickness of the laminate film structure (A) and (B) layers combined. If the layer (A) is thicker than 50%, the film may be too flexible and less heat resistant and could be too expensive for the desired application. If the layer (A) is thinner than 5%, the functionality of the layer (A) such as heat sealable properties may not occur.

The amount of propylene homo-polymer or copolymer of the layer (A) as the major component may be, for example, about 75-97 wt % of the layer (A). The preferred example of the ethylene-propylene copolymer is an isotactic ethylene-propylene impact copolymer of a specific rubber content. The impact copolymer may be an isotactic ethylene-propylene copolymer with an ethylene-propylene rubber content of about 10-30 wt % of the polymer wherein the ethylene content of the rubber may be about 10-80 wt % of the rubber. The impact copolymer may be manufactured in two reactors. In the first reactor, propylene homopolymer may be produced and conveyed to the second reactor that also contains a high concentration of ethylene. The ethylene, in conjunction with the residual propylene left over from the first reactor, copolymerizes to form an ethylene-propylene rubber. The resultant product has two distinct phases: a continuous rigid propylene homopolymer matrix and a finely dispersed phase of ethylene-propylene rubber particles.

The rubber content may be in the 10-30 wt % range depending on the desired end-use properties. It is this mixture of two phases--the propylene homopolymer matrix and the dispersed phase of ethylene-propylene rubber--that provides the impact resistance and toughening properties that impact copolymers are known for. Ethylene-propylene impact copolymers are distinctly different from conventional ethylene-propylene random copolymers which are typically polymerized in a single reactor, generally have a lower ethylene content (typically 0.5 wt % to 6 wt %) wherein the ethylene groups are randomly inserted by a catalyst along the polypropylene backbone chain, and do not include an ethylene-propylene rubber content.

A suitable example of propylene homo-polymer is Total 3271. The resin has a melt flow rate of about 1.5 g/10 minutes at 230° C., a melting point of about 236° C., and a density of about 0.905 g/cm³. A suitable example of an ethylene-propylene copolymer is Total Petrochemical's 5571. This resin has a melt flow rate of about 7 g/10 minutes at 230° C., a melting point of about 160-165° C., a Vicat softening point of about 148° C., and a density of about 0.905 g/cm³. Another example of a suitable ethylene-propylene impact copolymer is Total Petrochemical's 4180 with a melt flow rate of about 0.7 g/10 minutes at 230° C., a melting point of about 160-165° C., a Vicat softening point of about 150° C., and a density of about 0.905 g/cm³. Other suitable ethylene-propylene copolymers include Sunoco Chemical's (now Braskem) TI-4015-F2 with a melt flow rate of 1.6 g/10 minutes at 230° C. and a density of about 0.901 g/cm³ and ExxonMobil Chemical's PP7033E2 with a melt flow rate of about 8 g/10 minutes at 230° C. and a density of about 0.9 g/cm³.

The layer (A) formulation may include at least one thermoplastic elastomer as a minority component. A thermoplastic elastomer can be described as any of a family of polymers or polymer blends (e.g. plastic and rubber mixtures) that resemble elastomers in that they are highly resilient and can be repeatedly stretched and, upon removal of stress, return to close to its original shape; is melt processable at an elevated temperature (uncrosslinked); and does not exhibit significant creep properties. Thermoplastic elastomers typically have a density between 0.860 and 0.890 g/cm³ and a molecular weight M_{w} of 100,000 or greater. “Plastomers” differ from elastomers: A plastomer can be defined as any of a family of ethylene-based copolymers (i.e. ethylene alpha-olefin copolymer) that have properties generally intermediate to those of thermoplastic materials and elastomeric materials (thus, the term “plastomer”) with a density of less than 0.900 g/cm³ (down to about 0.865 g/cm³) at a molecular weight M_{w} between about 5000 and 50,000, typically about 20,000 to 30,000.

One of the elastomers the film may include is propylene-butene elastomer preferably having a butene of about 15-30 wt %. The amount of this propylene-butene elastomer used in the layer (A) may be 3-15 wt %, preferably 4-10 wt % of the layer (A). This ratio of elastomer and the major ethylene-propylene copolymer resin results in a good balance between heat seal initiation temperature, heat seal strengths, hermeticity in retorting applications, clarity, and low odor, particularly after machine direction orientation to impart directional tear characteristics. For example, if the content is less than 3 wt %, the layer (A) may not have enough desired heat sealable properties. If the content is more than 15 wt %, the film may not be heat resistant enough for retort packaging applications.

A preferred proplylene-butene elastomer is metallocene-catalyzed propylene-butene elastomer. The metallocene-catalyzed propylene-butene random elastomer preferably has 20-40 wt % butene content of the elastomer and the resulting polymer is amorphous or of low crystallinity, and is of very low density compared to typical polyethylenes, polypropylenes, and polybutenes. The metallocene catalysis of such elastomers results in a narrow molecular weight distribution; typically, M_{w}/Mₙ is 2.0 polydispersity. Comonomer dispersion is also narrower than in a comparable Ziegler-Natta catalyzed elastomer. This, in turn, results in an elastomer which provides lower seal initiation temperature and maintains high seal strength when used as a heat sealant modifier.

Suitable and preferred metallocene-catalyzed propylene-butene elastomer materials include those manufactured by Mitsui Chemicals under the tradename Tafmer® and grade names XM7070 and XM7080. These are propylene-butene low molecular weight, low crystallinity copolymers. XM7070 is about 26 wt % butene content; XM7080 is about 22 wt % butene. They are characterized by a melting point of 75° C. and 83° C., respectively; a Vicat softening point of 67° C. and 74° C., respectively; a density of 0.883-0.885 g/cm³; a T_{g} of about −15° C.; a melt flow rate at 230° C. of 7.0 g/10 minutes; and a molecular weight of 190,000-192,000 g/mol. XM7070 is preferred due to its higher butene content. The metallocene propylene-butene elastomers are in contrast to typical ethylene-propylene or propylene-butene or ethylene-propylene-butene random copolymers used for heat sealant resin layers in coextruded BOPP films such as Sumitomo SPX78H8 which are long-chain, high molecular weight polymers with significantly higher molecular weights on the order of 350,000 to 400,000 g/mol.

The metallocene propylene-butene elastomers are also in contrast to non-metallocene Ziegler-Natta catalyzed propylene-butene elastomers such as Mitsui Tafmer® XR110T. XR110T has a butene content of about 25.6 wt % and molecular weight of about 190,185 g/mol which is similar to XM7070, but its density of 0.89 g/cm³, melting point of 110° C., and Vicat softening point of 83° C. are all higher than its metallocene-catalyzed counterpart XM7070 butene-propylene elastomer. Additionally, due to the Ziegler catalyst system, the molecular weight distribution of the non-metallocene catalyzed butene-propylene elastomer XR100T is much wider than the metallocene-catalyzed butene-propylene elastomer XM7070. Consequently, the properties and heat sealable properties of a non-metallocene-catalyzed butene-propylene elastomer may be much different than those of a metallocene-catalyzed butene-propylene elastomer.

Another elastomer component in the layer (A) may be ethylene-butene elastomer preferablyof which butene content would be prefereably about 15-35 wt %. The amount of this ethylene-butene elastomer used in the layer (A) may be up to 10 wt %. The addition of this ethylene-butene copolymer elastomer can help to improve further seal initiation temperature properties, although too much use (for example, more than 10 wt %) of metallocene ethylene-butene elastomer can sacrifice overall heat seal strengths which may be critical in some retort packaging applications.

A suitable and preferred ethylene-butene elastomer is metallocene-catalyzed grade, for example, Mitsui Tafmer® A4085S grade. A4085S has a butene content of about 15-35 wt % of the polymer, a melt flow rate of about 6.7 g/10 minutes at 230° C., melting point of about 75° C., Tg of about −65 to −50° C., Vicat softening point of about 67° C., and a density of about 0.885 g/cm³. Suitable amounts of this metallocene ethylene-butene elastomer may be less than 10 wt % of the layer, preferably 3-4 wt % of the layer.

In this embodiment, an optional amount of antiblocking agent may be added to the mixed resin film layer for aiding machinability and winding. An amount of an inorganic antiblock agent can be added in the amount of 100-5,000 ppm of the core resin layer, preferably 500-1000 ppm. Preferred types of antiblock are spherical sodium aluminum calcium silicates or amorphous silica of nominal 6 μm average particle diameter, but other suitable spherical inorganic antiblocks can be used including crosslinked silicone polymer or polymethylmethacrylate, and ranging in size from 2 μm to 6 μm. Migratory slip agents such as fatty amides and/or silicone oils can also be optionally employed in the film layer either with or without the inorganic antiblocking additives to aid further with controlling coefficient of friction and web handling issues. Suitable types of fatty amides are those such as stearamide or erucamide and similar types, in amounts of 100-5000 ppm of the layer. Preferably, stearamide is used at 500-1000 ppm of the layer. A suitable silicone oil that can be used is a low molecular weight oil of 350 centistokes which blooms to the surface readily at a loading of 400-600 ppm of the layer. However, if the films are to be used for metallizing or high definition process printing, it is recommended that the use of migratory slip additives be avoided in order to maintain metallized barrier properties and adhesion or to maintain high printing quality in terms of ink adhesion and reduced ink dot gain.

In all these embodiments, the film is monoaxially oriented in one direction to a certain amount. It is this monoaxial orientation that imparts the directional or linear tearing properties that make it useful in the end use such as pouching applications. The preferred direction of the orientation is machine direction (MD) by roll stretching rather than transverse direction (TD) considering the feasibility of process and equipment.

The amount of orientation is an important attribute. Too low orientation may cause some issues such as uneven film profile, gauge bands, and uneven stretch marks as well as not enough directional tearable properties. Too much orientation may cause some issues such as film breakage as well as poor heat seal properties despite the effort of resin formulation to improve seal properties as mentioned above. Without being bound by any theory, this is believed to be due to the fact that the orientation process aligns the amorphous regions into a more ordered configuration, raising the Tg of the film, and thus, seal properties are poorer.

The inventers diligently examined the influence of orientation to directional tearable and heat sealable properties determined in the Test Methods section, and achieved film designs with better seal properties by controlling the orientation of the film, not only by stretching ratio but also by including other controllable parameters such as refractive index without jeopardizing other critical qualities.

The amount of orientation is determined by refractive index of the film. The film has birefringence because of the monoaxial orientation. As the value of delta n represented in the formula (1)—which is the absolute value of the difference between the refractive index in MD from the refractive index in TD—gets larger, the film is considered to have more orientation in one direction than the other.

delta n=|n(MD)−n(TD)|×1000 (1)

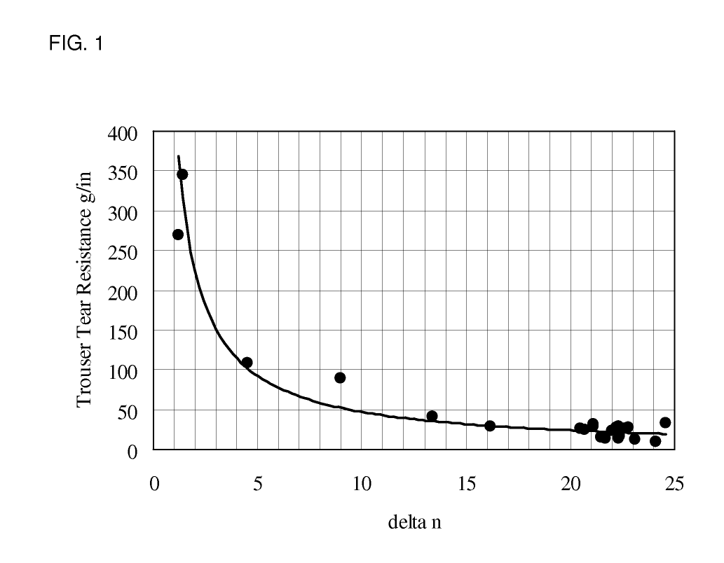

The films have the value of delta n between 5 to 25 inclusive, preferably 5 to 22 inclusive, more preferably 10 to 20 inclusive. The inventors have found that the directional tear properties saturate at about a delta n value of 25 and not much improvement could be expected by further orientation (see FIG. 1). If the delta n value is greater than 25, in return, it gets more difficult to stretch the film (film breaks due to the high stretching ratio) and the film may not have enough heat sealable properties. If the value delta n is less than 5, the film may not have enough directional tear properties. The inventers found that the directional tearable properties exponentially deteriorate at about 5 or less of the delta n value as seen in FIG. 1. FIG. 1 plots the relationship between Trouser tear resistance versus delta n. For directional tear properties, the lower the Trouser tear resistance is, the better the directional tear property is. Preferably, the Trouser tear resistance for a satisfactory directional tear film is 100 g/in or less. This correlates to delta n values of about 5 or greater.

The refractive index is controlled not only by nominal stretching ratio, but also by other factors such as the amount of heat being applied to the film. In general, a higher stretching ratio would result in higher refractive index of the film in the stretching direction if the heat profile of the stretching condition is same. To achieve the range of the above value, the nominal stretching ratio may be 2-7 times in one direction, preferably 2 to 5 times, more preferably 2 to 4 times with substantially no orientation in the other direction.

The heat profile of the stretching condition can be set from about 90° C. to 140° C. for the roll stretching in MD. This temperature can be adjusted according to the equipment such as a type of roll surface (metal surface, silicone surface, Teflon surface etc) and layout of the equipment such as roll configuration, positions of nip rolls and gap at stretching zone (gap between the lower speed or “slow stretch” roll right before stretching and the higher speed or “fast stretch” roll right after stretching). To achieve precise stretching, it is preferred that this gap is smaller, preferably, essentially a zero gap.

Following is an example of process to make films of this invention. In the above embodiments of multi-layer films, the respective layers can be coextruded through a multi-layer compositing die such as a 2- or 3-layer die, and cast onto a chill roll to form a solid film suitable for further processing. In the case of a single layer film, the respective layer may be extruded through a single-layer die and cast onto a chill roll to form a solid film suitable for further processing. Extrusion temperatures are typically set at 235-270° C. with a resulting melt temperature at the die of about 230-250° C.

The extruded sheet may be cast onto a cooling drum whose surface temperature may be controlled between 20° C. and 60° C. to solidify the non-oriented laminate sheet. The non-oriented laminate sheet may be stretched in the machine direction as mentioned above, and the resulting stretched sheet may be annealed or heat-set at about 130° C. to 150° C. in the final zones of the machine direction orientation section to reduce internal stresses and minimize thermal shrinkage and to obtain a dimensionally stable monoaxially oriented laminate sheet. After orientation, the typical film thickness may be 50-200 μm and most preferably, 70-100 μm for the retort package application. The monoaxially oriented sheet may then pass through a discharge-treatment process on one side or both sides of the film such as an electrical corona discharge to impart a higher surface wetting tension and a suitable surface for lamination to other films as desired. The film may be then wound into roll form.

As examples of the discharge-treatment process, the following can be selected: flame treatment, atmospheric plasma, corona discharge, or corona discharge in a controlled atmosphere of nitrogen, carbon dioxide, or a mixture thereof, with oxygen excluded and its presence minimized. The latter method of corona treatment in a controlled atmosphere of a mixture of nitrogen and carbon dioxide results in a treated surface that includes nitrogen-bearing functional groups, preferably at least 0.3 atomic % or more, and more preferably, at least 0.5 atomic % or more. The discharge-treated mixed resin layer is then well suited for subsequent purposes of laminating, coating, printing, or metallizing.

The discharge-treated surface of the resin blend layer may be metallized. The unmetallized laminate sheet may be first wound in a roll. The roll may be placed in a metallizing chamber and the metal vapor-deposited on the discharge-treated mixed resin metal receiving layer surface. The metal film may include titanium, vanadium, chromium, manganese, iron, cobalt, nickel, copper, zinc, aluminum, gold, or palladium, the preferred being aluminum. Metal oxides can also be utilized, the preferred being aluminum oxide. The metal layer can have a thickness between 5 and 100 nm, preferably between 20 and 80 nm, more preferably between 30 and 60 nm; and an optical density between 1.5 and 5.0, preferably between 2.0 and 4.0, more preferably between 2.3 and 3.2. The metallized film may be then tested for oxygen and moisture gas permeability, optical density, metal adhesion, metal appearance and gloss, and can be made into an adhesive laminate structure.

This invention will be better understood with reference to the following examples, which are intended to illustrate specific embodiments within the overall scope of the invention.

### Test Methods

The various properties in the above examples were measured by the following methods:

### Heat Sealable Properties

(1) Heat seal strength: Measured by using a Sentinel sealer model 12 ASL at 25 psi, 1.0 second dwell time, with heated flat upper seal jaw Teflon coated, and unheated lower seal jaw, rubber with glass cloth covered. The film sample is heat-sealed to itself at the desired seal temperature(s) in the Sentinel sealer (e.g. 154° C.). To prevent the film from sticking to the sealer's jaws, the test film can be laid onto a heat-resistant film such as a biaxially oriented nylon or polyethylene terephthalate film (PET). These two films are then folded over such that the nylon or PET film is outermost and in contact with the heated sealer jaws; the test film is then the inner layer and will seal to itself upon application of heat and pressure. A 20 μm thick PET film is used for this invention; if too thick, this may interfere with thermal transfer to the test film. The test film should be inserted between the heat sealer's jaws such that the film's machine direction is perpendicular to the heat sealer jaws. Heat seal temperatures may be increased at desired intervals, e.g. 5° C. increments. The respective seal strengths are measured using an Instron model 4201 tensile tester. The heat-sealed film samples are cut into 1-inch wide strips along the machine direction; the two unsealed tails placed in the upper and lower Instron clamps, and the sealed tail supported at a 90 degree angle to the two unsealed tails for a 90 degree. T-peel test. The peak and average seal strength is recorded. The value of 8000 g/inch or higher at 175° C. (350° F.) seal temperature is considered as acceptable (marginal), 12000 g/inch is considered as preferred.

(2) Seal initiation temperature: Heat seal initiation temperature (SIT) was measured by using a Sentinel sealer model 12 ASL at 25 psi, 1.0 second dwell time, with heated flat upper seal jaw Teflon coated, and unheated lower seal jaw, rubber with glass-cloth covered. The film sample is heat-sealed to itself at various desired seal temperatures in the Sentinel sealer and then the respective seal strengths are measured using an Instron model 4201 tensile tester as discussed above for heat seal strength determination. The Seal Initiation Temperature is defined as the seal temperature at which the film demonstrated a minimum of 2000 g/in heat seal strength. The preferred SIT value is 175° C. (330° F.) or lower.

Directional Tearable Properties

(1) Trouser tear resistance: Trouser tear resistance of the film is measured in MD according to ASTM D 1938-08 using Instron model 4201. The specimen is carefully cut into the shape by aligning the directions of the specimen and the direction to be tested. The average value in the oriented direction of 100 g/inch or less is considered as acceptable, 50 g/inch or less as preferable.

(2) Qualitative evaluation: Directional tear is tested qualitatively by notching a piece of test film on the edge and tearing by hand at the notch to initiate the tear. The notch is made parallel to the orientation direction and the tear will be propagated along the orientation direction. The tear is initiated from the notch by hand and observation made as to whether any stress-whitening, deformation or the consistency of the torn edges occurs. The qualitative directional tear property is categorized and ranked as the following five situation and appearance:

Rank 1 (Excellent): no stress-whitening or deformation, torn edges are consistent and propagate cleanly, the tear propagates in a straight line from the notch across the width of the sheet parallel to the machine direction.

Rank 2 (Good): torn edges are consistent and propagate cleanly, the tear propagates most likely (more than 90%) in a straight line from the notch across the width of the sheet parallel to the machine direction. No stress-whitening or deformation is observed.

Rank 3 (Marginal): torn edges are consistent and propagate cleanly, the tear propagates likely (more than 80%) in a straight line from the notch across the width of the sheet parallel to the machine direction. Few stress-whitening or deformation is observed occasionally.

Rank 4 (Not acceptable): stress-whitening or deformation is likely observed, torn edges are not consistent and do not propagate cleanly, the tear often propagates in an angled direction from the desired (machine) direction.

Rank 5 (Bad): the tear initiation at the notch shows stress-whitening or deformation; and/or the tear propagation is ragged, or is non-linear or non-parallel to the machine direction of the film, is propagated at an angle to the machine direction edge of the film

Amount of orientation: Amount of orientation in MD and TD of the film is determined by measuring the refractive index with an Abbe refractometer using the following procedure;

To determine n (MD) (i.e. refractive index of MD), the specimen to be measured must be cut out from the film; the running edge of the specimen must run precisely in direction TD. To determine n (TD) (i.e. refractive index of TD), the specimen to be measured must be cut out from the film; the running edge of the specimen must run precisely in direction MD. The specimens should be taken from the middle of the film web. Care must be taken that the Abbe refractometer is at a temperature of 23° C. Using a glass rod, some methyl salicylate (n=1.536) is applied to the lower prism, which is cleaned thoroughly before the measurement procedure. The specimen cut out in direction TD is firstly laid on top of this, in such a way that the entire surface of the prism is covered. Using a paper wipe, the film is firmly pressed flat onto the prism, so that it is firmly and smoothly positioned thereon. The excess of liquid must be sucked away. A little of the test liquid is then dropped onto the film. The second prism is swung down into place and pressed firmly into contact. The indicator scale is now turned until a transition from light to dark could be seen in the field of view in the range from 1.49 to 1.52. The transition line from light to dark is brought to the crossing point of the two diagonal lines (in the eyepiece). The value now indicated on the measurement scale is read off and entered into the test record. This is the refractive index n (MD). Then, the specimen strip cut out in direction MD is placed in position and the refractive index of TD is determined in a corresponding manner. Three samples of each variable are measured to be averaged. The birefringence orientation amount (delta n) in one direction value is then calculated from the refractive index by the following formula (1):

delta n=|n(MD)−n(TD)|×1000 (1)

Preferably, desirable values of delta n indicating excellent directional tear properties are in the range of 5 to 25, and more preferably 10-20.

### EXAMPLE 1

The resin components were dry-blended together at the ratio shown in Table 1 and extruded in a single layer using a single screw extruder at nominal 260° C. and cast and quenched on a matte finish chill roll at nominal 25° C. The obtained cast sheet was monoaxially oriented in the machine direction by roll stretching at preheat/stretching temperatures of the rolls and at the MD stretching ratio as shown in Table 1. The stretched film was sequentially cooled down and annealed in the same MD machine at 90° C. The total thickness of this film substrate after monoaxial orientation was ca. 80 μm. The film was passed through a corona treater for discharge treatment (4 kW) on one side of the film and wound into roll form. The film was tested for refractive index, directional tear performance and heat sealability properties. As shown in Table 2, the film of Example 1 has a refractive index delta n of 21.5 and average Trouser tear of 15 g/in, indicating excellent directional tear. This is also verified by qualitative hand-tearing with a rating of “1”. Heat seal initiation temperature (SIT) and heat seal strength are also very satisfactory at 160° C. and over 9000 g/in, respectively.

### EXAMPLES 2 to 5

Example 1 was repeated except that the mixed resin blend and MD stretching conditions were modified as shown in Table 1 for additional Examples 2 through 5. These additional Examples used slightly different ratios of the same materials as Ex. 1 as noted (e.g. Examples 4 and 5), and were stretched at the same stretching temperature conditions as Ex. 1. Machine direction orientation ratios, however, were varied from Ex. 1, targeting higher ratios than that used in Ex. 1, from 5.8 to 7.0. As shown in Table 2, Ex. 2 to 5 exhibited similar delta n values, Trouser tear values, and satisfactory SIT and heat seal strengths as Ex. 1.

### EXAMPLES 7 to 16

Examples 7 to 13 evaluated use of blends of propylene homopolymer, block copolymer, and elastomer at varying stretching temperatures and ratios. Generally, stretching ratios were lower than Ex. 1 (except for Ex. 7), varying from 5.0 to 3.5. As shown in Table 2, Examples 7 to 13 show that the refractive index delta n is comparable to Example 1; Trouser tear values are slightly higher than Ex. 1; and qualitative tear rating is slightly worse. However, tear values are still very satisfactory. SIT is very good, same as Ex. 1, and heat seal strength is also very good, generally better than Ex. 1. The higher seal strengths may be attributable to the use of the propylene homopolymer and block copolymer blend.

Examples 14 to 16 explored the same resin formulation as the previous Examples 7 to 13 in this set but at much lower MD orientation ratios of 3.0 to 2.0. As Table 2 shows, these Examples showed a lower delta n refractive index value significantly lower than the previous Examples. However, Trouser tear values and qualitative hand-tearing ratings are still satisfactory. It should be noted that for Ex. 16, using the lowest MD orientation ratio of 2.0, that delta n is the lowest at 9.0, showed the highest Trouser tear value at 89 g/in, and a worser—but still acceptable—tear rating of “3”. SIT was still very comparable to Ex. 1 and seal strengths were significantly superior to Ex. 1. The improvement in seal strengths is likely attributable to the lower orientation ratios used in these three Examples.

### COMPARATIVE EXAMPLE 6

Comparative Example 6 used a resin formulation of 100 wt % propylene homopolymer with no modifying elastomers. CEx. 6 was mono-axially oriented at the same machine direction process temperatures and stretch ratio as Ex. 1. As can be seen in Table 2, although its delta n value, Trouser tear value, hand-tear ranking, and seal initiation temperature are comparable to Ex. 1, seal strength is significantly poorer and unsatisfactory. This loss in heat seal strength may be due to the lack of modifying elastomer content.

### COMPARATIVE EXAMPLE 17

Comparative Example 17 used the same resin formulation as Examples 7 through 16. MD preheat and stretch temperatures were similar to some of the Examples of this set; MD orientation ratio, however, was much lower at 1.5. As Table 2 indicates, refractive index delta n value was below 5.0 (i.e. 4.5), Trouser tear strength was greater than 100 g/in (i.e. 108 g/in), and qualitative hand-tear ranking was poor at “4”. This comparative example exhibited unacceptable linear tear properties. Heat seal SIT and strength was very good, however, likely due to the low orientation of the film.

### COMPARATIVE EXAMPLES 18 and 19

Example 1 was repeated except that the mixed resin blend and the cast film was wound without being stretched in MD (i.e. 1.0 MD stretch ratio). As shown in Table 1, CEx. 18 is the same formulation as Ex. 1, but mono-axially oriented at a lower ratio of 1.0. CEx. 19 is the same formulatio as Ex. 4, but mono-axially oriented at a lower ratio of 1.0. Both Comparative Examples used the same machine direction preheat and stretch temperatures as Ex. 1 and 4. As shown in Table 2, both CEx. 18 and 19 exhibit very low refractive index delta n values (1.2 and 1.4, respectively), very high Trouser tear values (270 and 345 g/in, respectively), and very poor hand-tear rankings of “5”. These Comparative Examples essentially had no linear tear properties. SIT and heat seal strengths, however, were very good.

### EXAMPLES 20 to 22

Examples 20 to 22 were two-layer coextruded film designs. The resin components for a skin layer A and a core layer B were dry-blended together at the ratios shown in Table 3 and co-extruded in two layers using two single-screw extruders at nominal 260° C. and cast and quenched on a matte finish chill roll at nominal 25° C. The obtained cast sheet was mono-axially oriented in the machine direction by roll stretching at preheat and stretching temperatures of the rolls similar as Ex. 1 and at the MD stretching ratio as shown in Table 3. The stretched film was sequentially cooled down and annealed in the same MD machine at about 90° C. The total thickness of this film substrate after monoaxial orientation was ca. 80 μm. The film was passed through a corona treater for discharge treatment (4 kW) on the skin layer A side of the film and wound into roll form. The film was tested for refractive index, directional tear performance, and heat sealability properties.

As shown in Table 4, the films of Examples 20 to 22 have shown good directional tear properties as indicated by refractive index delta n values, Trouser tear strengths, and hand-tear rankings of “2”. SIT and heat seal strengths are also excellent.

### Retort Test Example

To confirm the film is suitable for the use of retort pouching, the following test was performed.

The MD oriented polypropylene based film of Example 8 was laminated with an AlOx deposited biaxially oriented polyethylene terephthalate (PET) film having a thickness of 12 μm (“Barrialox” 1101 HG-CX from Toray Advanced Film, Co., Ltd.) and a commercially available biaxially oriented nylon film having a thickness of 15 μm, as the structure of PET/AlOx/adhesive/nylon/adhesive/Example 8 film (corona treatad side was faced toward the adhesive). The adhesive used was a commercially available retort grade two-component adhesive (Dow Adcote 812/Crosslinker 9L19), the target thickness of the adhesive was 3.5 μm.

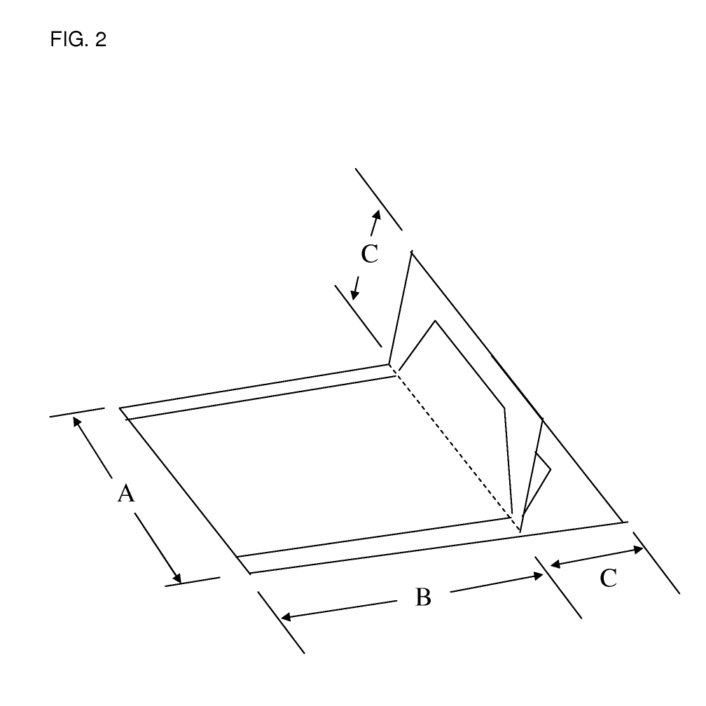

A pouch with a branched section was hand made as shown in FIG. 2 using the laminate such that the propylene based film was arranged inside the pouch. The dimensions of each part as shown in FIG. 2 are as follows. A=120 mm, B=100 mm, C=55 mm. The heat seal condition to make the pouch was same as the foregoing description and the width of each heat sealed area was ½ inch (besides the triangle part of the branched parts). The pouch having a branched section obtained using Example 8 was totally sealed after 200 g of distilled water was filled and was subjected to retort sterilization at 120° C. for 30 minutes.

After the pouch was cut out and the content water was discharged, the seal strength of the heat sealed part was measured. The pouch made from Example 8 remained enough heat seal strength as >8000 g /in.

Thus, the foregoing Examples show a way to maintain high seal strengths which is important in the use of retort pouching where high and hermetic seal strengths are needed to withstand the internal pouch pressure that results from retort cooking/sterilization and yet provide the desirable attribute of directional tear that is imparted from orientation stretching of the film. Since it is expected that seal performance will be worsened after orientation of the film, our invention unexpectedly has shown excellent seal performance with orientation of the film.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

TABLE 1

| | | Film Composition (wt %) | | | | | | |
|---|---|---|---|---|---|---|---|---|
| | | | | Block copolymer | Propylene- | Ethylene- | | |
| | | | Ethylene- | of Ethylene- | Butene | Buteve | MD Stretching | |
| | | Propylene | Propylene | Propylene | elastomer | elastomer | Temp profile | |
| | | homopolymer | copolymer | “Braskem | “Tafmer | “Tafmer | Preheat/Stretch | |
| | Structure | “Total 3271” | “Total 5571” | TI4015F” | XM7070” | A4085S” | (° C.) | Ratio |
| Ex. 1 | Single layer | | 92 | | 4 | 4 | 115/125 | 4.8 |
| Ex. 2 | Single layer | | 92 | | 4 | 4 | 115/125 | 5.8 |
| Ex. 3 | Single layer | | 92 | | 4 | 4 | 115/125 | 7.0 |
| Ex. 4 | Single layer | | 92 | | 8 | | 115/125 | 6.0 |
| Ex. 5 | Single layer | | 90 | | 10 | | 115/125 | 6.0 |
| Cex. 6 | Single layer | | 100 | | | | 115/125 | 4.8 |
| Ex. 7 | Single layer | 48 | | 48 | 4 | | 115/125 | 5.0 |
| Ex. 8 | Single layer | 48 | | 48 | 4 | | 115/125 | 4.0 |
| Ex. 9 | Single layer | 48 | | 48 | 4 | | 125/140 | 4.0 |
| Ex. 10 | Single layer | 48 | | 48 | 4 | | 115/125 | 3.5 |
| Ex. 11 | Single layer | 48 | | 48 | 4 | | 110/120 | 3.5 |
| Ex. 12 | Single layer | 48 | | 48 | 4 | | 100/110 | 3.5 |
| Ex. 13 | Single layer | 48 | | 48 | 4 | | 125/140 | 3.5 |
| Ex. 14 | Single layer | 48 | | 48 | 4 | | 115/125 | 3.0 |
| Ex. 15 | Single layer | 48 | | 48 | 4 | | 115/125 | 2.5 |
| Ex. 16 | Single layer | 48 | | 48 | 4 | | 115/125 | 2.0 |
| CEx. 17 | Single layer | 48 | | 48 | 4 | | 115/125 | 1.5 |
| CEx. 18 | Single layer | | 92 | | 4 | 4 | 115/125 | 1.0 |
| CEx. 19 | Single layer | | 92 | | 8 | | 115/125 | 1.0 |

TABLE 2

| | | | | Tearable Properties | | Heat Seal Properties | |
|---|---|---|---|---|---|---|---|
| | Refractive index | | | Average Trouser | Qualitative | SIT at 2000 g/in | Heat Seal Strength |
| | n (MD) | n (TD) | delta n | Tear in MD (g/in) | Rank | (° C.) | at 175° C. (g/in) |
| Ex. 1 | 1.5171 | 1.4956 | 21.5 | 15 | 1 | 160 | 9782 |
| Ex. 2 | 1.5183 | 1.4952 | 23.1 | 13 | 1 | 160 | 9256 |
| Ex. 3 | 1.5195 | 1.4954 | 24.1 | 10 | 1 | 165 | 8821 |
| Ex. 4 | 1.5158 | 1.4935 | 22.3 | 14 | 1 | 165 | 10319 |
| Ex. 5 | 1.5166 | 1.4942 | 22.4 | 16 | 1 | 170 | 10852 |
| Cex. 6 | 1.5179 | 1.4962 | 21.7 | 14 | 1 | 165 | 4627 |
| Ex. 7 | 1.5199 | 1.4953 | 24.6 | 33 | 2 | 160 | 10853 |
| Ex. 8 | 1.5171 | 1.4951 | 22.0 | 24 | 2 | 160 | 10627 |
| Ex. 9 | 1.5172 | 1.4967 | 20.5 | 26 | 2 | 160 | 10987 |
| Ex. 10 | 1.5159 | 1.4952 | 20.7 | 25 | 2 | 160 | 12003 |
| Ex. 11 | 1.5162 | 1.4951 | 21.1 | 31 | 2 | 160 | 11475 |
| Ex. 12 | 1.5175 | 1.4947 | 22.8 | 28 | 2 | 160 | 11895 |
| Ex. 13 | 1.5148 | 1.4937 | 21.1 | 29 | 2 | 160 | 11574 |
| Ex. 14 | 1.5128 | 1.4966 | 16.2 | 29 | 2 | 160 | 12580 |
| Ex. 15 | 1.5103 | 1.4969 | 13.4 | 42 | 2 | 160 | 12219 |
| Ex. 16 | 1.5074 | 1.4984 | 9.0 | 89 | 3 | 160 | 12440 |
| CEx. 17 | 1.5005 | 1.4960 | 4.5 | 108 | 4 | 160 | 12953 |
| CEx. 18 | 1.4941 | 1.4929 | 1.2 | 270 | 5 | 160 | 11230 |
| CEx. 19 | 1.4946 | 1.4932 | 1.4 | 345 | 5 | 160 | 12350 |

TABLE 3

| | | Film Composition for Skin | | | Film Composition for Core | | | | |
|---|---|---|---|---|---|---|---|---|---|
| | | layer A (wt %) | | | layer B (wt %) | | | | |
| | | | Block | | | Block | | | |
| | | | copolymer of | Propylene- | | copolymer of | Propylene- | | |
| | | | Propylene- | Butene | | Propylene- | Butene | MD Stretching | |
| | | Propylene | Butene | elastomer | Propylene | Butene | elastomer | Temp profile | |
| | | homopolymer | “Braskem | “Tafmer | homopolymer | “Braskem | “Tafmer | Preheat/Stretch | |
| | Structure | “Total 3271” | TI4015F” | XM7070” | “Total 3271” | TI4015F” | XM7070” | (° C.) | Ratio |
| Ex. 20 | A/B | 48 | 48 | 5 | 48 | 48 | 4 | 115/125 | 4.0 |
| Ex. 21 | A/B | 48 | 48 | 10 | 48 | 48 | 4 | 115/125 | 4.0 |
| Ex. 22 | A/B | 48 | 48 | 15 | 48 | 48 | 4 | 115/125 | 4.0 |

TABLE 4

| | | | | Tearable Properties | | Heat Seal Properties | |
|---|---|---|---|---|---|---|---|
| | Refractive index | | | Average Trouser | Qualitative | SIT at 2000 g/in | Heat Seal Strength |
| | n (MD) | n (TD) | delta n | Tear in MD (g/in) | Rank | (° C.) | at 175° C. (g/in) |
| Ex. 20 | 1.5175 | 1.4949 | 22.6 | 26 | 2 | 160 | 12627 |
| Ex. 21 | 1.5169 | 1.4947 | 22.2 | 28 | 2 | 160 | 12880 |
| Ex. 22 | 1.5166 | 1.4943 | 22.3 | 29 | 2 | 160 | 13280 |

We claim;:

1. A monoaxially oriented heat-sealable single layer film comprising a propylene homo-polymer or copolymer and 3-15 wt % of at least one elastomer, wherein a refractive index of the film satisfies the following condition:
5≦delta n≦25, wherein
delta n=|n(MD)−n(TD)|×1000,
n (MD) is a refractive index of the film in a machine direction, and
n (TD) is a refractive index of the film in a transverse direction.

2. The film of claim 1, comprising 75-97 wt % propylene homo-polymer or copolymer.

3. The film of claim 1, wherein the film comprises propylene-butene elastomer or ethylene-butene elastomer.

4. The film of claim 1, wherein the film comprises a propylene-butene elastomer having a butene content of 15-30 wt %.

5. The film of claim 1, wherein the film comprises a metallocene-catalyzed propylene-butene elastomer.

6. The film of claim 1, wherein the film comprises a metallocene catalyzed ethylene-butene elastomer.

7. The film of claim 1, further comprising an inorganic antiblock agent.

8. A food package comprising the film of claim 1.

9. A multi layer film comprising:
a heat sealable layer comprising a propylene homo-polymer or copolymer and at 3-15 wt. % of at least one elastomer; and a core layer,
wherein the refractive index of the film satisfies the following condition:
5≦delta n≦25, wherein
delta n=|n(MD)−n(TD)|×1000,
n (MD) is a refractive index of the film in a machine direction, and
n (TD) is a refractive index of the film in a transverse direction.

10. The film of claim 9, wherein the heat sealable layer comprises propylene-butene elastomer or ethylene-butene elastomer.

11. The film of claim 9, wherein the heat sealable layer has a thickness of 5-50% of the total thickness of the film.

12. The film of claim 9, wherein the core layer comprises an ethylene-propylene copolymer, or propylene copolymer.

13. The film of claim 9, wherein the core layer comprises an isotactic ethylene-propylene copolymer with an with an ethylene-propylene rubber content of 10-30 wt % and an ethylene content of the ethylene-propylene rubber is 10-80 wt %.

14. The film of claim 9, wherein the heat sealable layer comprises 75-97 wt % propylene homo-polymer or copolymer.

15. The film of claim 9, wherein the elastomer is a propylene-butene elastomer having a butene content of 15-30 wt %.

16. The film of claim 9, wherein the elastomer is a metallocene-catalyzed propylene-butene elastomer.

17. The film of claim 9, wherein the elastomer is a metallocene catalyzed ethylene-butene elastomer.

18. The film of claim 9, further comprising an inorganic antiblock agent.

19. A food package comprising the film of claim 9.

20. A method of making a monoxially oriented film comprising extruding a single layer film comprising a propylene homo-polymer or copolymer and 3-15 wt % of at least one elastomer; and
monoaxially orienting the single layer film,
wherein a refractive index of the monoaxially oriented film satisfies the following condition:
5≦delta n≦25, wherein
delta n=|n(MD)−n(TD)|×1000,
n (MD) is a refractive index of the film in a machine direction, and
n (TD) is a refractive index of the film in a transverse direction.

21. The method of claim 20, wherein the single layer film comprises 75-97 wt % propylene homo-polymer or copolymer.

22. The method of claim 20, wherein the single layer film comprises an elastomer propylene-butene elastomer or ethylene-butene elastomer.

23. The method of claim 20, wherein the single layer film comprises a propylene-butene elastomer having a butene content of 15-30 wt %.

24. A method of making a multilayer monoxially oriented film comprising co-extruding a heat sealable layer comprising a propylene homo-polymer or copolymer and at 3-15 wt. % of at least one elastomer, and a core layer,
wherein a refractive index of the monoaxially oriented film satisfies the following condition:
5≦delta n≦25, wherein
delta n=|n(MD)−n(TD)|×1000,
n (MD) is a refractive index of the film in a machine direction, and
n (TD) is a refractive index of the film in a transverse direction.

25. The method of claim 24, wherein the core layer comprises an ethylene-propylene copolymer.

26. The method of claim 24, wherein the heat sealable layer comprises 75-97 wt % propylene homo-polymer or copolymer.

27. The method of claim 24, wherein the at least one elastomer comprises propylene-butene elastomer or ethylene-butene elastomer.

28. The method of claim 24, wherein the at least one elastomer comprises a propylene-butene elastomer having a butene content of 15-30 wt %.
